(19) United States
(12) Patent Application Publication
(10) Pub. No.: US 2015/0188354 A1
(43) Pub. Date: Jul. 2, 2015

(54) INTERGRALLY ENCAPSULATED WIRELESS CHARGING DEVICE

(71) Applicant: BIWIN STORAGE TECHNOLOGY LIMITED, Shenzhen (CN)

(72) Inventors: Rixin SUN, Shenzhen (CN); Zhenhua LI, Shenzhen (CN)

(21) Appl. No.: 14/453,974

(22) Filed: Aug. 7, 2014

(30) Foreign Application Priority Data
Dec. 26, 2013 (CN) 201310732796.5

(51) Int. Cl. H02J 7/02; H02J 7/00

(52) U.S. Cl. CPC H02J 7/025; H02J 7/0042

(57) ABSTRACT

An integrally encapsulated wireless charging device includes a first circuit board, a magnetic isolation plate and a cord superimposed; the first circuit board has one lateral surface provided with a wireless power receiving module and another lateral surface provided with a first contact; the cord is superimposed on the lateral surface with the wireless power receiving module of the first circuit board, while the external dimension of the cord is not greater than that of the first circuit board; and the magnetic isolation plate is arranged between the cord and the first circuit board. The device has beneficial effects that: the charging receiving module and the cord which are originally separated or arranged in parallel are superimposed and partitioned by a magnetic isolation plate there-between; the first circuit board for external connection is provided with the first contact.

### TECHNICAL FIELD

The present invention relates to the field of wireless charging, in particular to an integrally encapsulated wireless charging device.

### DESCRIPTION OF THE RELATED ART

As handheld electronic products become more and more popular, customers have new requirements for the charging mode of these products. Traditional powercords are the “last cords” of portal electronic products. To remove the last cords, wireless charging technology is favored among the majority of customers. The wireless charging technology provides simple operation, can avoid disorder of cords, is not limited by the specifications of the charging adaptors, can seal the charging port to be adapted to environments with high temperature and humidity and much dust, and now has been applied to handheld commodities such as mobile phones and electronic toothbrushes. Dealers have also established strategy consortiums (such as Wireless Power Consortium WPC) to develop various wireless power specifications (such as Qi) to meet the marketing demands. A handheld electronic product with the wireless charging function must be internally equipped with a group of wireless power receiving modules which can receive electromagnetic waves, convert the electromagnetic waves into electricity and then further transmit the converted electricity into the battery in the product to charge the product. The electromagnetic waves come from a wireless power emitter out of the product.

In the prior art, if a product needs the wireless charging function, plural functional blocks are needed to form the wireless power receiving module, including a full synchronous rectifier, a low-dropout linear regulator (LDO), a micro control unit (MCU), a communication modulation module, a cord, and drive components such as the resistor and the capacitor. Those function blocks shall be installed on a printed circuit board (PCB) as shown in FIG. 1 and then mutually connected through the wire in the PCB. In the wireless power receiving module 200 as shown in FIG. 1, each of the above functional blocks is an encapsulated integrated circuit. The wireless power receiving module 200 includes plural functional blocks, so the PCB on the layer below the wireless power receiving module is of complicated layout and irregular shape and has a size which is difficult to reduce. For manufacturers intending to install the wireless power receiving module in their own products, the plural functional blocks cause difficulties in integration in the product and have a direct influence on the specifications of products with the wireless charging function such that the volumes and weights of products with the wireless power receiving module are more difficult to reduce. Therefore, a solution is in urgently needed in this field to reduce the difficulties in integration of manufacturers' systems and the wireless power receiving module and also shrink the space occupied by the wireless power module in the product.

### BRIEF SUMMARY OF THE INVENTION

The objective of the present invention is to provide a compactly structured and integrally encapsulated wireless charging device to overcome the above defects. The objective of the present invention is fulfilled in this way: an integrally encapsulated wireless charging device is provided, comprising a first circuit board, a magnetic isolation plate and a cord which are superimposed; the first circuit board has one lateral surface provided with a wireless power receiving module and another lateral surface provided with a first contact; the cord is superimposed on the lateral surface with the wireless power receiving module of the first circuit board, while the external dimension of the cord is not greater than that of the first circuit board; and the magnetic isolation plate is arranged between the cord and the first circuit board.

In the above structure, the first circuit board comprises a first area and a second area on the periphery of the first area; the first area is provided with the wireless power receiving module; the magnetic isolation plate is provided with a through-hole corresponding to the first area of the first circuit board; and the cord is superimposed in the second area of the first circuit board.

In the above structure, the first area is located in the middle portion of the first circuit; and the cord around the periphery of the first area is superimposed in the second area.

In the above structure, a second circuit board is provided. The second circuit board comprises at least two layers. Each layer of the second circuit board is provided with an annular wire. The annular wires of adjacent layers are electrically connected through via-hole in the circuit board to form the cord. The external dimension of the second circuit board is not greater than that of the first circuit board.

In the above structure, the second circuit has one lateral surface provided with a second contact in electric connection with the annular wire in the second circuit board; the lateral surface with the second contact of the second circuit board is superimposed at the lateral surface with the wireless power receiving module of the first circuit board; the first circuit board is provided with a third contact at a position corresponding to the second contact; the third contact is electrically connected with the wireless power receiving module; and the second contact and the third contact are electrically connected through solder paste thereon;

In the above structure, the second contact is arranged on the periphery of the annular wire of the second circuit board.

In the above structure, the first circuit board, the magnetic isolation plate and the cord are superimposed and integrally encapsulated.

In the above structure, the overall encapsulation shape of the first circuit board, magnetic isolation plate and cordare identical with the SIM card.

In the above structure, the overall encapsulation shape of the first circuit board, magnetic isolation plate and cordare identical with a memory card; and the memory card may be a MMC, MS, SD, TF, CF or XQC type memory card.

In the above structure, the overall encapsulation shape of the first circuit board, magnetic isolation plate and cord and the structure of the first contact on the first circuit board are identical with a data memory interface; and the data memory interface may be a USB, 1394 or Lighting interface.

Compared with a common wireless charging device, the invention has beneficial effects that: the charging receiving module and the cord which are originally separated or arranged in parallel are mutually superimposed and partitioned by a magnetic isolation plate there-between; the first circuit board for external connection is provided with the first contact; the overall structure is compact and conveniently encapsulated and produced; and manufacturers are only required to add a connection base on their own devices, and the connection base is matched and electrically connected with the first contact on the first circuit board such that their devices have the wireless charging function conveniently and quickly.

### BRIEF DESCRIPTION OF THE SEVERAL VIEWS OF THE DRAWINGS

The specific structure of the invention is described in further detail with reference to the attached drawings.

FIG. 1 is an external view of the wireless charging device in the prior art.

FIG. 2 is a structural view of embodiment 1 of the present invention.

FIG. 3 is a schematic view of one lateral surface of the first circuit board in another embodiment of the present invention.

FIG. 4 is a schematic view of another lateral surface of the first circuit board in another embodiment of the present invention.

FIG. 5 is a schematic view of one lateral surface of the second circuit board in another embodiment of the present invention.

FIG. 6 is a schematic view of another lateral surface of the second circuit board in another embodiment of the present invention.

FIG. 7 is a schematic view of the surface of the magnetic isolation plate in another embodiment of the present invention.

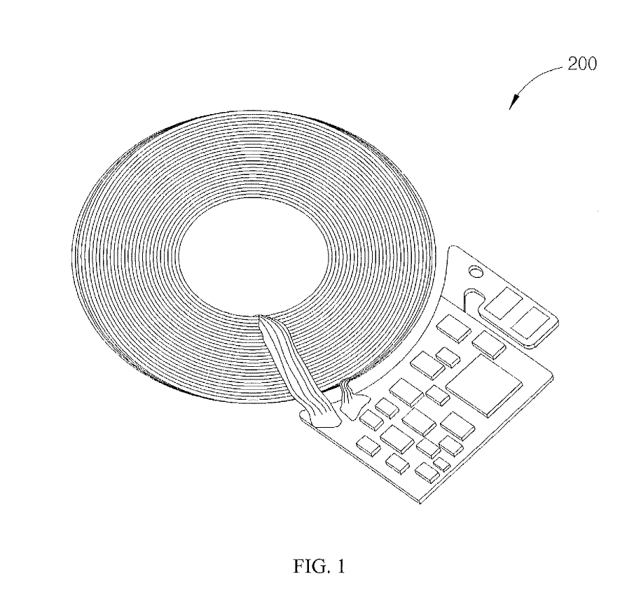

1—The first circuit board; 11—wireless charging removing module; 12—the first contact; 13—the first area; 14—the second area; 15—the third contact; 2—magnetic isolation plate; 21—through-hole; 3—cord; 4—the second circuit board; 41—via-hole; 42—the second contact; 200—wireless power receiving module.

### DETAILED DESCRIPTION OF THE INVENTION

The technical content, structural features, objectives and effects of the present invention are described in detail with reference to embodiments and attached drawings.

The present invention relates to an integrally encapsulated wireless charging device, comprising a first circuit board, a magnetic isolation plate and a cord which are superimposed.

The first circuit board, the magnetic isolation plate and the cord are superimposed and integrally encapsulated. Namely, the above three are bonded together in a superimposed way and encapsulated by using materials such as the epoxy, finally forming an integrally encapsulated wireless charging device of complete function modularization. This module can independently conduct the function of receiving wireless charging. Thus, the wireless charging function can be integrated in existing products on condition of least changes in the existing product design.

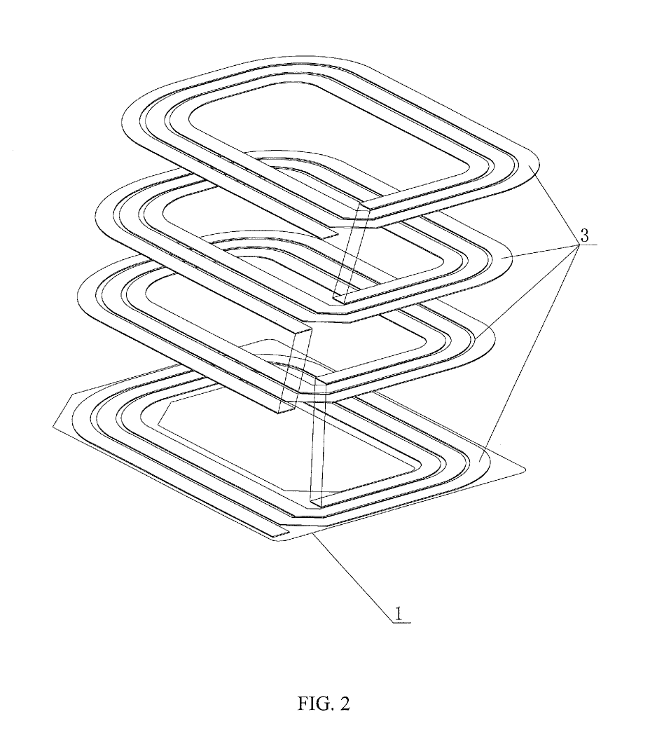

FIG. 2 is a schematic view of a structure that a multi-layer cord 3 is encapsulated on one side of the first circuit board 1.

Furthermore, the encapsulation specification of the above first circuit board, the magnetic isolation plate and the cordare identical with the specification of the current SIM card, various memory cards or data interfaces, and thus can be directly used in products configured with the above slot.

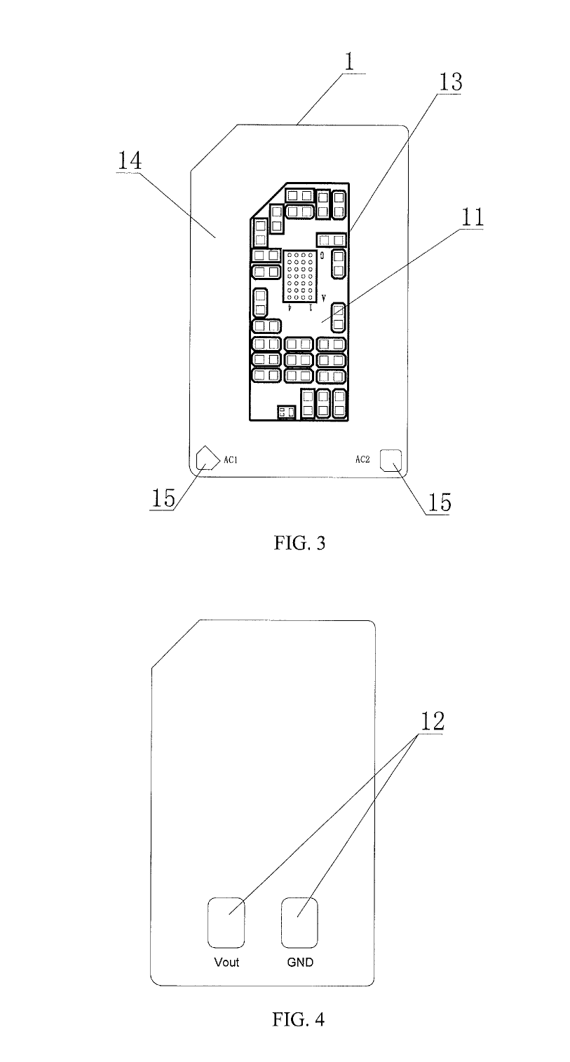

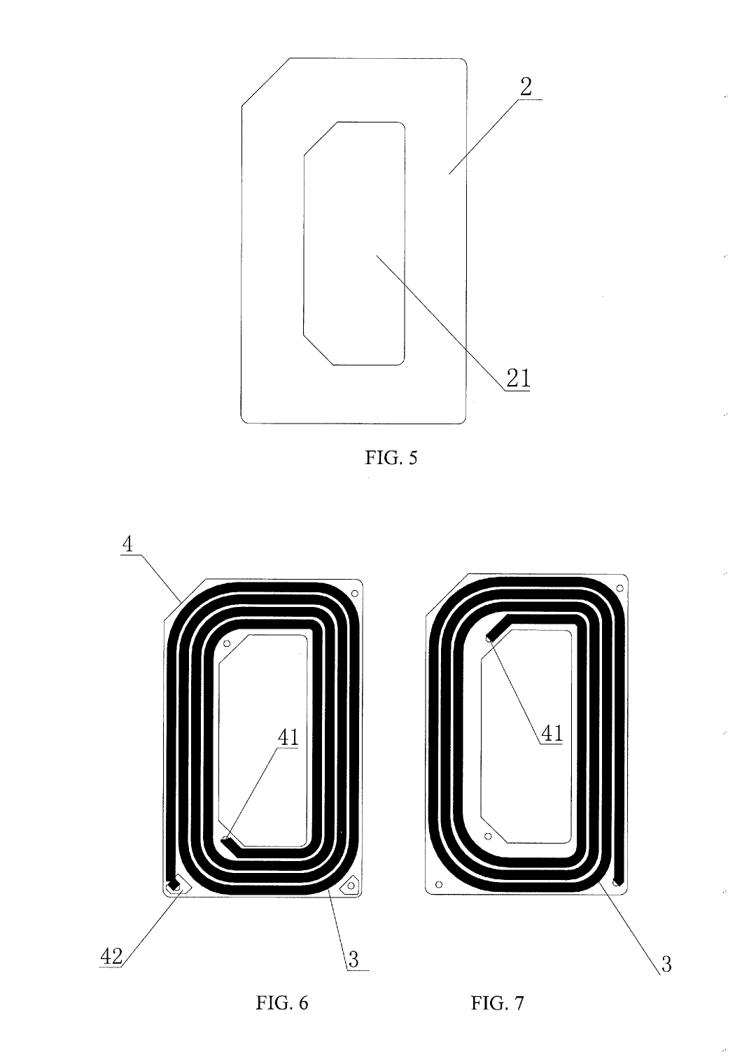

To better understand the technical solution of the present invention, the solution of the present invention is described in detail with reference to an embodiment and FIGS. 2-6. The product in the embodiment as shown in FIGS. 3-7 is encapsulated to form a structure similar to the SIM card, and the actual structure is not limited to that as shown in those figures.

An integrally encapsulated wireless charging device is provided, wherein:

A first circuit board 1 has one lateral surface provided with a wireless power receiving module 11 and another lateral surface provided with a first contact 12. The first contact 12 is mainly electrically connected with the battery at the application apparatus end, and can steadily supply the current to the battery in the working state.

A cord 3 is superimposed on the lateral surface with the wireless power receiving module 11 of the first circuit board 1, and the external dimension of the cord 3 is not greater than that of the first circuit board 1.

A magnetic isolation plate 2 is arranged between the cord 3 and the first circuit board 1.

The magnetic isolation plate 2 here is made of high-magnetic-conduction material, mainly used to guide the magnetic lines of force so as to protect units of the wireless power receiving module 11 on the first circuit board 1 behind the magnetic isolation plate 2.

The optimal magnetic isolation plate 2 is made from high-temperature resistant materials with magnetic conductivity which is required to be above 45 and the resistance above 1 G Ohm.

Thus it can be seen that, according to the technical solution of the present invention, the charging receiving module and the cord 3 which are originally separated or arranged in parallel are mutually superimposed and partitioned by a magnetic isolation plate 2 there-between; the first circuit board 1 for external connection is provided with the first contact 12; the overall structure is compact and conveniently encapsulated and produced; and manufacturers are only required to add a connection base on their own devices, and the connection base is matched and electrically connected with the first contact 12 on the first circuit board 1 such that their devices have the wireless charging function conveniently and quickly.

In an embodiment, one lateral surface of the first circuit board 1 is divided into a first area 13 and a second area 14 around the periphery of the first area 13. The first area 13 of the first circuit board 1 is provided with the wireless receiving charging module 11; the cord 3 is superimposed in the second area 14 of the first circuit board 1; and the magnetic isolation plate 2 is provided with a through-hole 21 corresponding to the first area 13 of the first circuit board 1. This structure can help minimize the overall thickness of the integrally encapsulated wireless charging device. For the whole device, heights of various components such as the chip, capacitor, and resistor in the wireless power receiving module 11 are major factors affecting the thickness. If the first circuit board 1, the magnetic isolation plate 2 and the cord 3 are just simply superimposed, the total thickness is the sum of three thicknesses. Therefore, in this embodiment, the feature that the cord 3 has a winding space in the center and shall be wound to the biggest extent is fully used to integrate the disperse parts of the wireless power receiving module 11 in the space in the cord 3, thus reducing overall thickness of the product and endowing the product with a bigger application value.

Thus, the device in this embodiment is three-in-one mode. During production, components of the wireless power receiving module 11 are pasted in the first area 13 of the first circuit board 1 first, and then the magnetic isolation plate 2 is adhered to the periphery of the components. The magnetic isolation plate has a high magnetic flux, capable of preventing the magnetic lines of force from affecting the components in the rear of the charging line. Finally, the cord 3 is arranged above the magnetic isolation plate 2. The cord 3 serves as the receiver of the magnetic lines of force. Those three parts are bonded together in a superimposed way to avoid increase to overall thickness and encapsulated by using materials such as the epoxy, finally forming an integrally encapsulated wireless charging device of complete function modularization. This module can independently conduct the function of receiving wireless charging.

In one embodiment, the first area 13 is located in the middle portion of the first circuit 1; and the cord 3 around the periphery of the first area 13 is superimposed in the second area 14. Through arrangement of the wireless power receiving module 11 in the middle portion of the first circuit board 1, the space of the circuit board can be used to the maximum extent, so the cord 3 can be wound to the maximum circle to strengthen the wireless receiving effect. In one embodiment, a second circuit board 4 is provided. The second circuit board 4 at least comprises two layers (the circuit board may be two-layer, four-layer, eight-layer or multi-layer). An annular wire is wound on each layer of the second circuit board 4. The diameter of the annular wire shall be big enough to pass sufficient current and relatively low DC resistance. The annular wire of each layer realizes electric connection through the via-hole 41 in the circuit board so as to increase the number of windings of the cord 3. All annular wires form the cord 3. The external dimension of the second circuit board 4 is not greater than that of the first circuit board 1.

In this embodiment, the originally independently wound cord 3 is arranged in an at least two-layer second circuit board 4, thus enhancing the product strength, bringing convenience to product encapsulation and improving strength after encapsulation.

Furthermore, to facilitate connection of the above structure, in one embodiment, one lateral surface of the second circuit is provided with a second contact 42. The annular wire in the second circuit board 4 is electrically connected with the second contact 42. The lateral surface with the second contact 42 of the second circuit board 4 is superimposed on the lateral surface with the wireless power receiving module 11 of the first circuit board 1. The first circuit board 1 is provided with a third contact 15 at a position corresponding to the second contact 42. The third contact 15 is electrically connected with the wireless power receiving module 11. The second contact 42 and the third contact 15 may be square or ball-shaped and are electrically connected through solder paste thereon, thus realizing the electric connection between the first circuit board 1 and the second circuit board 4 in the encapsulation process such that the induction cord 3 can be connected into the wireless power receiving module 11. In one embodiment, the second contact 42 is arranged on the periphery of the annular wire of the second circuit board 4. This structure can effectively use the space of the product and minimize the influence on annular wire arranged in the second circuit board 4.

In one embodiment, as shown in figure 3, the overall encapsulation shape of the first circuit board 1, the magnetic isolation plate 2 and the cord 3 is similar to the SIM card, and the first circuit board 1 comprises two first contacts 12. In one embodiment, the overall encapsulation shape of the first circuit board 1, the magnetic isolation plate 2, and the cord 3 and the structure of the first contacts 12 on the first circuit board 1 are identical with the SIM card.

In one embodiment, the overall encapsulation shape of the first circuit board 1, the magnetic isolation plate 2 and the cord 3 and the structure of the first contacts 12 on the first circuit board 1 are identical with a memory card; and the memory card may be an MMC, MS, SD, TF, CF or XQC type memory card.

In on embodiment, the overall encapsulation shape of the first circuit board 1, magnetic isolation plate 2 and cord 3 and the structure of the first contact 12 on the first circuit board 1 are identical with a data memory interface; and the data memory interface may be a USB, 1394 or Lighting interface.

The above are only the exemplary embodiment of the present invention, which cannot limit patent scope of the present invention. Within the spirit and principle of the present invention, any modification of the equivalent structure or equivalent flow, or direct or indirect application in other related technical fields all shall be fall within the protection scope of the present invention.

1. An integrally encapsulated wireless charging device, comprising: a first circuit board, a magnetic isolation plate and a cord which are superimposed;
the first circuit board having one lateral surface provided with a wireless power receiving module and another lateral surface provided with a first contact;
a cord being superimposed on the lateral surface with the wireless power receiving module of the first circuit board, the external dimension of the cord being not greater than that of the first circuit board; and
magnetic isolation plate being arranged between the cord and the first circuit board.

2. The integrally encapsulated wireless charging device according to claim 1, wherein the first circuit board comprises a first area and a second area on the periphery of the first area; the first area is provided with the wireless power receiving module; the magnetic isolation plate is provided with a through-hole corresponding to the first area of the first circuit board; and the cord is superimposed in the second area of the first circuit board.

3. The integrally encapsulated wireless charging device according to claim 2, wherein the first area is located in the middle of the first circuit board; and the cord around the periphery of the first area is superimposed in the second area.

4. The integrally encapsulated wireless charging device according to claim 1, wherein a second circuit board is provided, the second circuit board comprising at least two layers, each layer of the second circuit board being provided with an annular wire, the annular wires of adjacent layers being electrically connected through via-hole in the circuit board to form the cord; the external dimension of the second circuit board being not greater than that of the first circuit board.

5. The integrally encapsulated wireless charging device according to claim 4, wherein one lateral surface of the second circuit board is provided with a second contact; the annular wire in the second circuit board is electrically connected with the second contact; the lateral surface with the second contact of the second circuit board is superimposed on the lateral surface with the wireless power receiving module of the first circuit board; the first circuit board is provided with a third contact at a position corresponding to the second contact; the third contact is electrically connected with the wireless power receiving module; and the second contact and the third contact are electrically connected through solder paste thereon.

6. The integrally encapsulated wireless charging device according to claim 5, wherein the second contact is arranged on the periphery of the annular wire of the second circuit board.

7. The integrally encapsulated wireless charging device according to claim 1, wherein the first circuit board, the magnetic isolation board and the cord are superimposed and integrally encapsulated.

8. The integrally encapsulated wireless charging device according to claim 7, wherein the overall encapsulation shape of the first circuit board, the magnetic isolation plate and the cord is identical with the SIM card.

9. The integrally encapsulated wireless charging device according to claim 7, wherein the overall encapsulation shape of the first circuit board, the magnetic isolation plate and the cord is identical with a memory card; and the memory card may be an MMC, MS, SD, TF, CF or XQC memory card.

10. The integrally encapsulated wireless charging device according to claim 7, wherein the overall encapsulation shape of the first circuit board, the magnetic isolation plate and the cord and the structure of the first contact on the first circuit board are identical with a data memory interface; and the data memory interface may be a USB, 1394 or Lighting interface.

11. The integrally encapsulated wireless charging device according to claim 2, wherein a second circuit board is provided, the second circuit board comprising at least two layers, each layer of the second circuit board being provided with an annular wire, the annular wires of adjacent layers being electrically connected through via-hole in the circuit board to form the cord; the external dimension of the second circuit board being not greater than that of the first circuit board.

12. The integrally encapsulated wireless charging device according to claim 3, wherein a second circuit board is provided, the second circuit board comprising at least two layers, each layer of the second circuit board being provided with an annular wire, the annular wires of adjacent layers being electrically connected through via-hole in the circuit board to form the cord; the external dimension of the second circuit board being not greater than that of the first circuit board.

13. The integrally encapsulated wireless charging device according to claim 2, wherein the first circuit board, the magnetic isolation board and the cord are superimposed and integrally encapsulated.

14. The integrally encapsulated wireless charging device according to claim 3, wherein the first circuit board, the magnetic isolation board and the cord are superimposed and integrally encapsulated.

15. The integrally encapsulated wireless charging device according to claim 5, wherein the first circuit board, the magnetic isolation board and the cord are superimposed and integrally encapsulated.

16. The integrally encapsulated wireless charging device according to claim 6, wherein the first circuit board, the magnetic isolation board and the cord are superimposed and integrally encapsulated.
